(19) United States
(12) Patent Application Publication
(10) Pub. No.: US 2014/0377495 A1
(43) Pub. Date: Dec. 25, 2014

(54) ADHESIVE ARTICLE

(71) Applicant: CHIN-CHOU YANG, NEW TAIPEI CITY (TW)

(72) Inventor: CHIN-CHOU YANG, NEW TAIPEI CITY (TW)

(21) Appl. No.: 14/196,230

(22) Filed: Mar. 4, 2014

(30) Foreign Application Priority Data
Jun. 25, 2013 (TW) 102122461

(51) Int. Cl. G09F 3/02

(52) U.S. Cl. CPC G09F 3/02; G09F 2003/023
USPC 428/42.2

(57) ABSTRACT

An adhesive article comprises a body, a primary release sheet and at least one secondary release sheet group. The body has an adhesive layer laminated on its back surface. The adhesive layer is composed of a positioning zone and a laminating zone. The primary release sheet and the at least one secondary release sheet group are respectively laminated on the positioning zone and the laminating zone. By the positioning zone, the laminating zone, the primary release sheet and the at least one secondary release sheet group, the adhesive article maintains a sufficient adhesive force and the body remains intact and will not stick to fingers or itself by the adhesive layer during repeated removing and laminating.

### BACKGROUND OF THE INVENTION

1. Field of the Invention

The present invention relates to an adhesive article, especially to an adhesive article having an adhesive layer capable of being attached to objects with repeated repositioning.

2. Description of the Prior Art(s)

Adhesive articles with an adhesive layer are widely supplied in markets, such as stickers, nameplates and self adhesive hook. Regardless of type, the adhesive article has a body and a release paper. The front surface of the body has a text or a symbol for labeling or instructions. The adhesive layer is disposed at the back surface of the body. The release paper covers the back surface of the body.

When an adhesive article is in use, the release paper is removed first such that the back surface of the adhesive layer is exposed. Then the body is directly attached to a predetermined position by the adhesive layer.

However, when a user is attaching an adhesive article to an object, the body is not always immediately attached to a correct or ideal position by the adhesive layer but may rather require several attempts; as such, the body may have to be removed from an inappropriate position and reattached to a correct or more appropriate position. However, the adhesive layer has considerable adhesive force, resulting in difficulty in removing the body from the inappropriate position. As a result, either the body is destroyed or the adhesive force of the adhesive layer is reduced. Especially, when the adhesive article has been removed and reattached for multiple times, the body and the adhesive layer are both damaged seriously.

Moreover, as the release paper is removed and the adhesive layer is exposed when attaching and removing the body, oftentimes fingers of a user stick to the adhesive layer or the body sticks to itself by the adhesive layer; both of which cause inconvenience for use.

To overcome the shortcomings, the present invention provides an adhesive article with an adhesive layer to mitigate or obviate the aforementioned problems.

### SUMMARY OF THE INVENTION

The main objective of the present invention is to provide an adhesive article with an adhesive layer, which can be removed and laminated for multiple times while the adhesive layer maintains a sufficient adhesive force and the adhesive article remains intact and will not stick to itself or to fingers of a user.

The adhesive article with an adhesive layer in accordance with the present invention has a body, a primary release sheet, and at least one secondary release sheet group. The body has the adhesive layer disposed thereon. The adhesive layer is laminated on the back surface of the body. The adhesive layer is composed of a positioning zone and a laminating zone. The primary release sheet is laminated on the positioning zone. The at least one secondary release sheet group is laminated on the laminating zone.

In accordance with the present invention, as the body is laminated on the predetermined position by the positioning zone of the adhesive layer, the laminating zone of the adhesive layer is still covered by the secondary release sheet group; thereby the situations that fingers of a user stick to the adhesive layer or the body sticks to itself by the adhesive layer are avoided. In addition, when the predetermined position is found inappropriate, the body is easily removed from the inappropriate position and relocated at an ideal position; thereby the body can be removed and laminated for multiple times without damage. Also, as the laminating zone of the adhesive layer is protected by the secondary release sheet group, sufficient adhesive force is provided by the laminating zone to stick the body tightly to the ideal position after the ideal position is confirmed. Therefore, the adhesive article with the adhesive layer in accordance with the present invention is convenient and practical.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a first embodiment of an adhesive article with an adhesive layer in accordance with the present invention;

FIG. 2 is an exploded view of the adhesive article in FIG. 1;

FIG. 3 is a front view of the adhesive article in FIG. 1;

FIG. 4 is a rear view of the adhesive article in FIG. 1;

FIG. 5 is a first operational view of the adhesive article in FIG. 1;

FIG. 6 is a second operational view of the adhesive article in FIG. 1;

FIG. 7 is a third operational view of the adhesive article in FIG. 1;

FIG. 8 is a fourth operational view of the adhesive article in FIG. 1;

FIG. 9 is a rear view of a second embodiment of an adhesive article in accordance with the present invention;

FIG. 10 is a rear view of a third embodiment of an adhesive article in accordance with the present invention.

### DETAILED DESCRIPTION OF THE PREFERRED EMBODIMENTS

### Embodiment 1

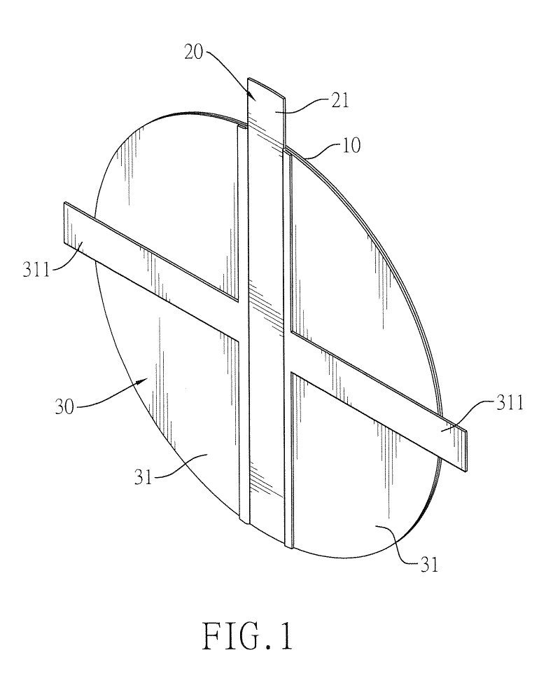

With reference to FIG. 1, an adhesive article with an adhesive layer in accordance with the present invention has a body 10, a primary release sheet 20, and a secondary release sheet group 30.

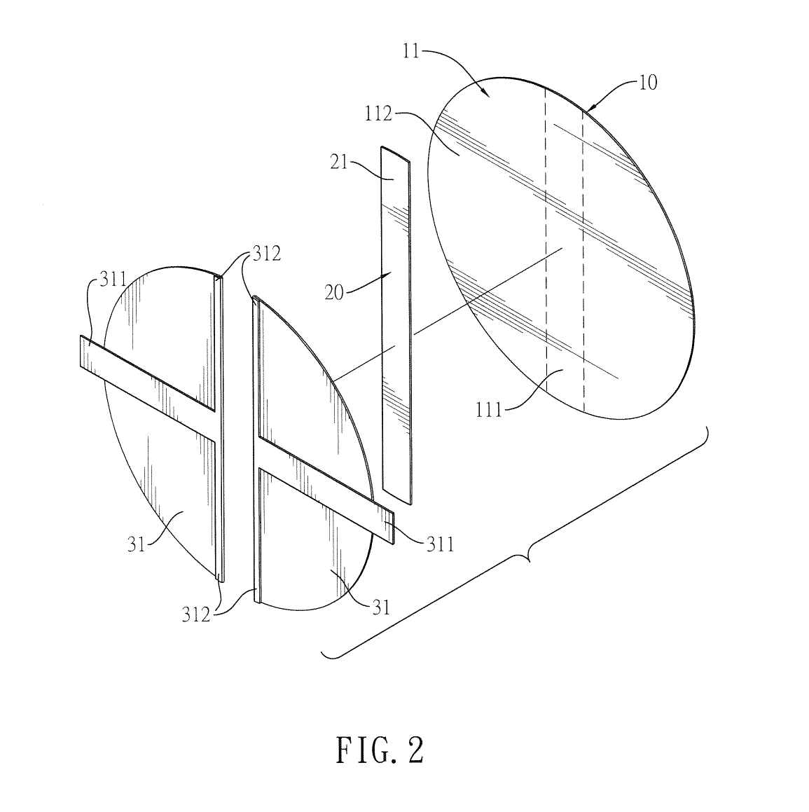

With reference to FIGS. 1 and 2, the body 10 has a pattern part and the adhesive layer 11. The pattern part is letters or symbols that are printed, carved, stuck, or injection formed on a front surface of the body 10. The adhesive layer 11 is laminated on a back surface of the body 10. The adhesive layer 11 is composed of a positioning zone 111 and a laminating zone 112. In the present embodiment, the positioning zone 111 is connected with the laminating zone 112.

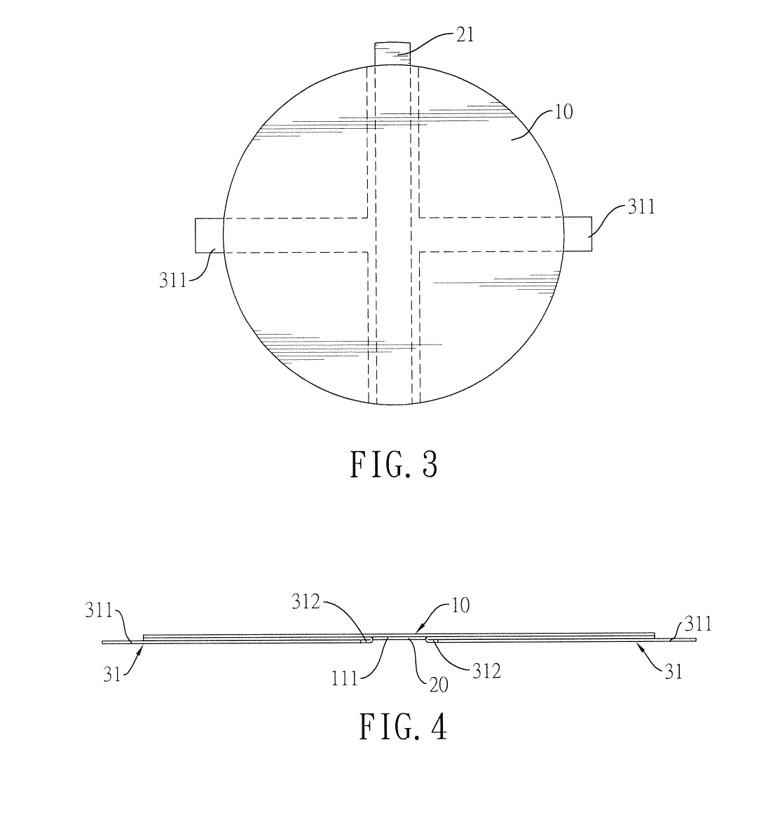

With reference to FIGS. 1 to 4, the primary release sheet 20 is laminated on the positioning zone 111. The primary release sheet 20 has a pulling part 21 extending out from an edge of the primary release sheet 20. In the present embodiment, the pulling part 21 of the primary release sheet 20 extends to protrude out of an edge of the body 10 for 1 to 2 centimeters.

With reference to FIGS. 1 to 4, the secondary release sheet group 30 is laminated on the laminating zone 112. The secondary release sheet group 30 has two secondary release sheets 31. The two secondary release sheets 31 are located at two opposite sides of the primary release sheet 20. Each secondary release sheet 31 has a pulling part 311 disposed at an inner edge of the secondary release sheet 31 and folded on a back surface of the secondary release sheet 31. In the present embodiment, each secondary release sheet 31 has a strengthening part 312 disposed between and connected to the pulling part 311 and the inner edge of the secondary release sheet 31. Along the inner edge of each secondary release sheet 31, the strengthening part 312 has a length equal to a length of the inner edge and larger than a length of the pulling part 311. The pulling part 311 of each secondary release sheet 31 extends and protrudes out of the edge of the body 10 for 1 to 2 centimeters.

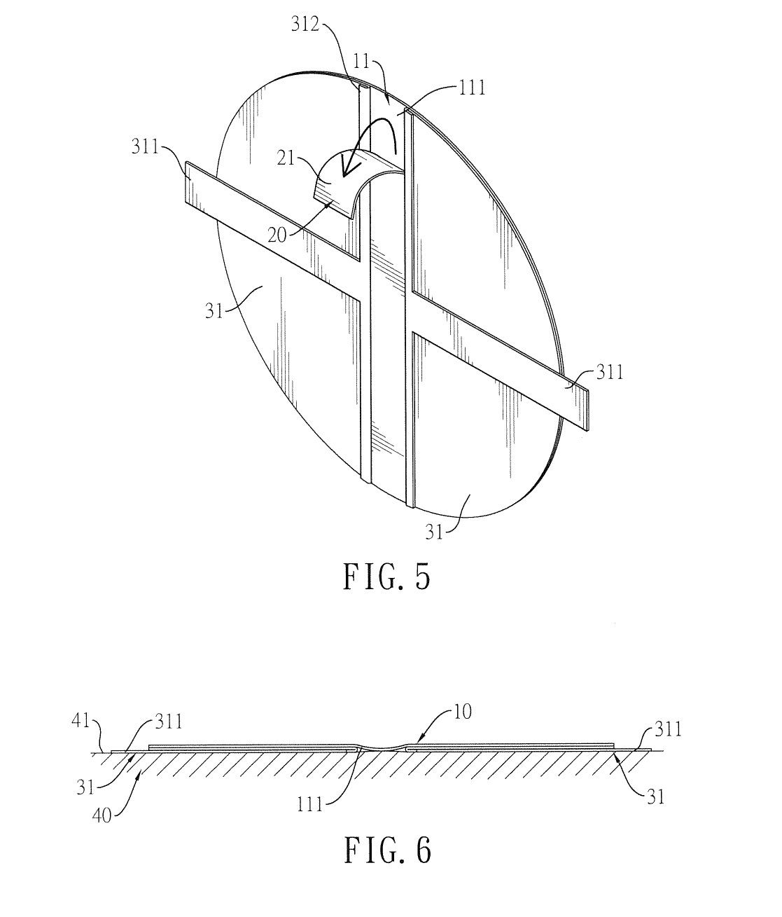

With reference to FIGS. 1, 2 and 4 to 6, after the primary release sheet 20 is removed from the body 10 by pulling the pulling part 21 of the primary release sheet 20, the positioning zone 111 of the adhesive layer 11 is exposed. Then the body 10 is attached to a predetermined position located on a surface 41 of an object 40 by the positioning zone 111 of the adhesive layer 11.

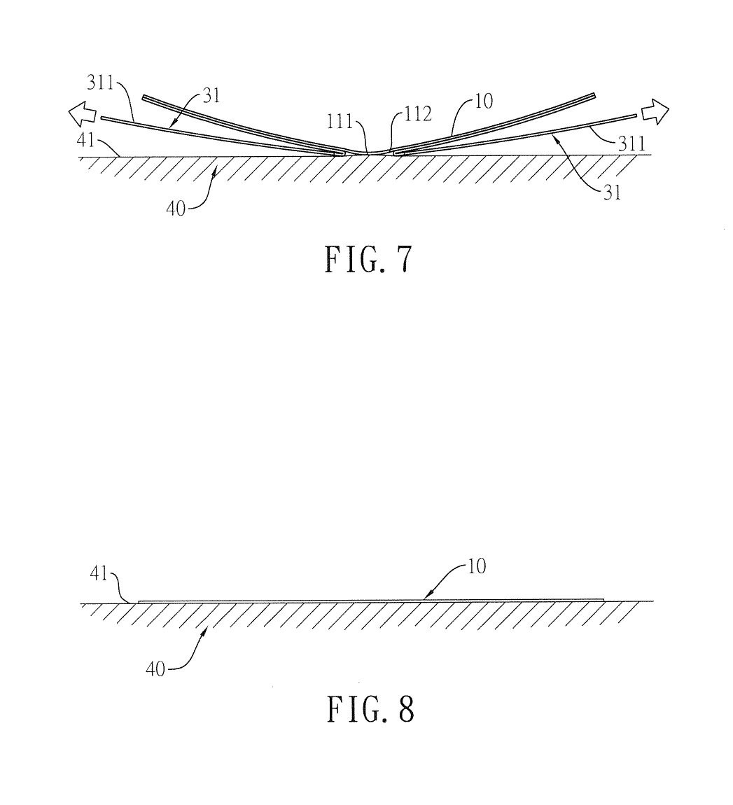

With reference to FIGS. 6 to 8, after the predetermined position is confirmed, the pulling part 311 of each secondary release sheet 31 is pulled. Each secondary release sheet 31 is separated from the laminating zone 112 from the inner edge toward an outer edge of the secondary release sheet 31 while the laminating zone 112 is gradually exposed and is stuck to the predetermined position on the surface 41 of the object 40. Therefore, the body 10 is laminated on the object 40.

At first, the body 10 is laminated on the predetermined position by the positioning zone 111 of the adhesive layer 11, and the laminating zone 112 of the adhesive layer 11 is still covered by the secondary release sheet group 30 to prevent situations that fingers of a user stick with the adhesive layer 11 or the body 10 sticks to itself by the adhesive 11 layer.

In addition, since the body 10 is laminated on the predetermined position by the positioning zone 111 of the adhesive layer 11 only in the beginning, the body 10 is easily removed from the inappropriate position and relocated at an ideal position when the predetermined position is found inappropriate. Thus, the body 10 can be removed and laminated for multiple times without damage. Because the laminating zone 112 of the adhesive layer 11 is still protected by the secondary release sheet group 30, the laminating zone 112 remains unused and intact. Therefore, the laminating zone 112 provides a sufficient adhesive force to enable the body 10 to stick tightly to the ideal position. Preferably, based on the total area of the adhesive layer 11, the area of the positioning zone 111 of the adhesive layer 11 of the body 10 ranges from 5% to 10% and the area of the laminating zone 112 of the adhesive layer 11 of the body 10 ranges from 90% to 95%.

By the pulling parts 311, the primary release sheet 20 and the two secondary release sheets 30 are easily removed from the adhesive layer 11. Further, as the pulling part 311 of each secondary release sheet 31 extends and protrudes out of the edge of the body 10, fingers of a user are located out of the edge of the body 10 instead of on the back surface of the body 10. Thus, the fingers do not interfere with the secondary release sheet 31 while pulling the pulling parts 311 away from the adhesive layer. Moreover, the pulling parts 311 extend and protrude out of the edge of the body 10 for 1 centimeter to 2 centimeters in an ergonomic manner since the user generally pulls the pulling parts by the tip segments of the fingers.

Furthermore, the strengthening part 312 of each secondary release sheet 31 enforces the structural strength between the pulling part 311 and the inner edge of each secondary release sheet 31 so that the pulling part 311 is not easily separated from the inner edge of each secondary release sheet 31 when the pulling part 311 is pulled. In addition, by the strengthening part 312 of each secondary release sheet 31, when the pulling part 311 is pulled, a uniform pulling force is applied to the inner edge of each secondary release sheet 31 such that each secondary release sheet 31 is separated from the laminating zone 112 from the inner edge toward the outer edge. Therefore, the laminating zone 112 is orderly and gradually exposed and stuck to the object 40.

### Embodiment 2

The present invention is similar to Embodiment 1. The difference between the present embodiment and Embodiment 1 is described as follows.

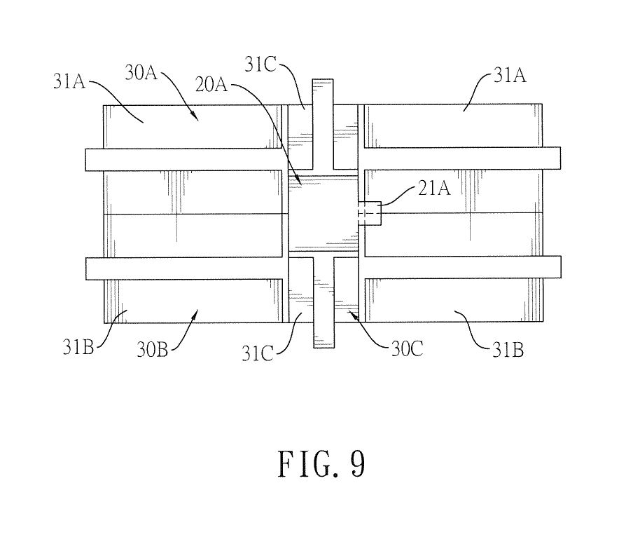

With reference to FIG. 9, the article has the body, the primary release sheet 20A and three secondary release sheet groups 30A, 30B, 30C. The positioning zone is located at the center of the back surface of the body. The laminating zone surrounds the positioning zone. Each of the three secondary release sheet groups 30A, 30B, 30C is laminated on the laminating zone and connected to the primary release sheet 20A. The three secondary release sheet groups 30A, 30B, 30C are connected to each other. One of the secondary release sheets 31A, 31B, 31C of one of the secondary release sheet groups 30A, 30B, 30C is connected to another one of the secondary release sheets 31A, 31B, 31C of another secondary release sheet group 30A, 30B, 30C.

### Embodiment 3

The present embodiment is similar to Embodiment 1. The difference between the present embodiment and Embodiment 1 is described as follows.

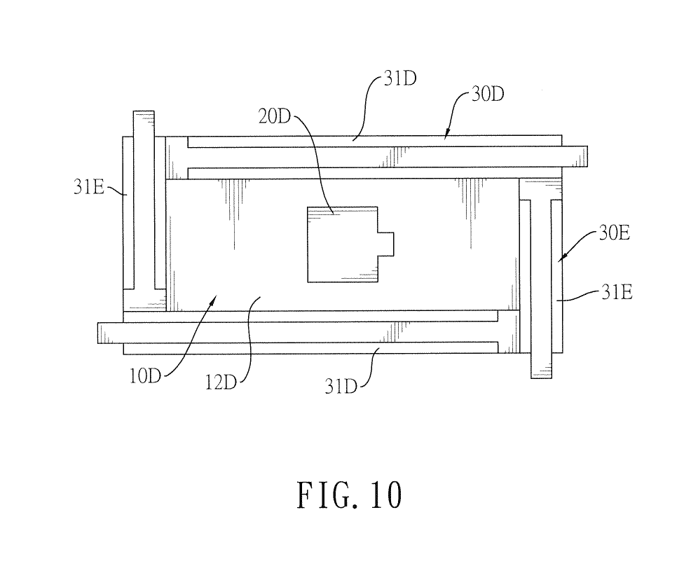

With reference to FIG. 10, the adhesive article has the body 10D, the primary release sheet 20D and two secondary release sheet groups 30D, 30E. The positioning zone is located at the center of the back surface of the body 10D. The laminating zone surrounds the positioning zone. The body 10D has a non-adhesive zone 12D located at the back surface of the body 10D. The non-adhesive zone 12D is located between the positioning zone and the laminating zone of the adhesive layer. Each secondary release sheet group 30D, 30E is laminated on the laminating zone. The two secondary release sheet groups 30D, 30E are connected to each other. One of the secondary release sheets 31D, 31E of one of the secondary releasing sheet groups 30D, 30E is connected to another one of the secondary release sheets 31D, 31E of another secondary release sheet group 30D, 30E.

With reference to FIGS. 1, 9 and 10, the number of the secondary release sheet group 30, 30A, 30B, 30C, 30D, 30E can be one or more. The number of the secondary release sheet group 30, 30A, 30B, 30C, 30D, 30E depends on, but is not limited to, the size, shape and texture of the body 10, 10D and user's demand.

Based on the above mentioned, by the positioning zone 111, the laminating zone 112, the primary release sheet 20, 20A, 20D, and the at least one secondary release sheet group 30, 30A, 30B, 30C, 30D, 30E, the adhesive article with the adhesive layer 11 in accordance with the present invention maintains a sufficient adhesive force, and the body 10, 10D remains intact and will not stick to fingers of a user or to itself by the adhesive layer 11 during removal and laminating of the body for multiple times. Therefore, the adhesive article is convenient and practical.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. An adhesive article comprising:
a body having
an adhesive layer laminated on a back surface of the body, the adhesive layer composed of
a positioning zone; and
a laminating zone;
a primary release sheet laminated on the positioning zone; and
at least one secondary release sheet group laminated on the laminating zone.

2. The adhesive article as claimed in claim 1, wherein
each of the at least one secondary release sheet group has
two secondary release sheets.

3. The adhesive article as claimed in claim 2, wherein
the two secondary release sheets of each of the at least one secondary release sheet group are located at two opposite sides of the primary release sheet.

4. The adhesive article as claimed in claim 2, wherein
each secondary release sheet of each of the at least one secondary release sheet group has
a pulling part disposed at an inner edge of the secondary release sheet and folded on the back surface of the body.

5. The adhesive article as claimed in claim 4, wherein
the pulling part of each secondary release sheet extends and protrudes out of an edge of the body.

6. The adhesive article as claimed in claim 5, wherein
the pulling part of each secondary release sheet extends and protrudes out of the edge of the body for a distance ranging from 1 centimeter to 2 centimeters.

7. The adhesive article as claimed in claim 4, wherein
each secondary release sheet of each of the at least one secondary release sheet group has
a strengthening part disposed between and connected to the pulling part and the inner edge of the secondary release sheet.

8. The adhesive article as claimed in claim 4, wherein
an area of the positioning zone of the adhesive layer of the body ranges from 5% to 10% based on a total area of the adhesive layer.

9. The adhesive article as claimed in claim 1, wherein
the primary release sheet has a pulling part.

10. The adhesive article as claimed in claim 1, wherein the adhesive article has
multiple secondary release sheet groups connected with each other.

11. The adhesive article as claimed in claim 1, wherein
the body has
a non-adhesive surface located between the positioning zone and the laminating zone.
